(19) United States
(12) Patent Application Publication
(10) Pub. No.: US 2023/0076799 A1
(43) Pub. Date: Mar. 9, 2023

(54) ELECTRONIC DEVICE WITH FINGERPRINT SENSOR AND HIGH RESOLUTION DISPLAY ADAPTED TO EACH OTHER

(71) Applicant: Egis Technology Inc., Hsinchu City (TW)

(72) Inventors: BRUCE C. S. CHOU, Hsinchu City (TW); Wan-Ting CHIEN, Hsinchu City (TW)

(21) Appl. No.: 17/759,503

(22) PCT Filed: Jul. 8, 2020
(86) PCT No.: PCT/CN2020/100770

§ 371 Date: Jul. 26, 2022

Related U.S. Application Data
(60) Provisional application No. 63/001,791, filed on Mar. 30, 2020.

(51) Int. Cl. G06V 40/13; H04M 1/02

(52) U.S. Cl. CPC G06V 40/1318; H04M 1/0266

(57) ABSTRACT

An electronic device with a fingerprint sensor and a high resolution display adapted to each other includes a display and a fingerprint sensor. The display has display pixels. A transversal pitch P is formed between adjacent two of the display pixels. The fingerprint sensor senses a fingerprint of a finger disposed on or above the display. The fingerprint sensor is a BSI fingerprint sensor and includes a sensing chip and an optical module. The sensing chip has sensing cells each having a transversal dimension A. The optical module disposed between the sensing chip and the display has a magnification power M, where A x M ≤ P, and A > 5 µm.

### CROSS-REFERENCE TO RELATED APPLICATIONS

This application is a U.S. National Stage under 35 U.S.C § 371 of International Application No. PCT/CN2020/100770 filed on Jul. 8, 2020, which claims priority of U.S. Provisional Application No. 63/001,791 filed on Mar. 30, 2020 under 35 U.S.C. § 119(e), the entire contents of which are hereby incorporated by reference.

### BACKGROUND OF THE INVENTION

### Field of the Invention

This disclosure relates to an electronic device, and more particularly to an electronic device with a fingerprint sensor and a high resolution display adapted to each other.

### Description of the Related Art

Today’s mobile electronic devices (e.g., mobile phones, tablet computers, notebook computers and the like) are usually equipped with user biometrics recognition systems including different techniques relating to, for example, fingerprint, face, iris and the like, to protect security of personal data. Portable devices applied to mobile phones, smart watches and the like also have the mobile payment function, which further becomes a standard function for the user’s biometrics recognition. The portable device, such as the mobile phone and the like, is further developed toward the full-display (or super-narrow border) trend, so that conventional capacitive fingerprint buttons can no longer be used, and new minimized optical imaging devices, some of which are similar to the conventional camera module having complementary metal-oxide semiconductor (CMOS) image sensor (referred to as CIS) sensing members and an optical lens module, are thus evolved. The minimized optical imaging device is disposed under the display as an under-display device. The image of the object (more particularly the fingerprint) placed above the display can be captured through the partial light-transmitting display (more particularly the organic light emitting diode (OLED) display), and this can be called as fingerprint on display (FOD).

The conventional optical fingerprint sensor is an optical sensor manufactured by the complementary-metal oxide semiconductor (CMOS) front-side illumination (FSI) technology mainly because a dimension of each sensing pixel ranges from 6 to 8 microns (µm) (or even larger). Compared with the conventional camera’s CMOS image sensor, the pixel dimension is smaller than 1 µm, wherein the whole industrial trend is that the pixel dimension gets smaller, and the total pixels get more.

However, the consideration of the FOD technology is completely different from that of the conventional camera’s CMOS image sensor because the sensor is disposed under the display having the transmission rate or transmittance to be considered. Also, the comparison algorithm for fingerprint recognition has a certain requirement on the image resolution (e.g., > 500 dots per inch (dpi)). So, the designs of the sensor and the display need to collocate with each other to obtain the optimized system function.

To sum up, the current display is continuously developed toward the high resolution target. The transmittance of the high resolution display is inevitably decreased, so that the light amount received by the optical fingerprint sensor gets lower. At present, the optical fingerprint sensor under the display with the low transmittance cannot achieve the effective sensing function.

### BRIEF SUMMARY OF THE INVENTION

It is therefore an objective of this disclosure to provide an electronic device with a fingerprint sensor and a high resolution display adapted to each other so that the fingerprint sensor can be designed according to the requirement of the resolution of the display to effectively perform under-display optical characteristic sensing.

To achieve the above-identified objective, this disclosure provides an electronic device including a display and a fingerprint sensor. The display has display pixels. A transversal pitch P is formed between adjacent two of the display pixels. The fingerprint sensor senses a fingerprint of a finger disposed on or above the display. The fingerprint sensor is a back-side illumination (BSI) fingerprint sensor, and includes a sensing chip and an optical module. The sensing chip has sensing cells each having a transversal dimension A. The optical module is disposed between the sensing chip and the display and has a magnification power M, where A × M ≤ P, and A > 5 µm.

With the electronic device having the fingerprint sensor and the high resolution display adapted to each other, optical fingerprint sensing can be implemented under the high resolution display according to the condition of A × M ≤ P, and the display and fingerprint sensing requirements of the future and currently developing mobile devices can be satisfied.

In order to make the above-mentioned content of this disclosure more obvious and be easily understood, preferred embodiments will be described in detail as follows in conjunction with the accompanying drawings.

### BRIEF DESCRIPTION OF THE SEVERAL VIEWS OF THE DRAWINGS

FIG. 1 is a characteristic graph showing examples of displays having different transmission rates.

FIG. 2A is a characteristic graph showing two fingerprint sensors.

FIG. 2B is a schematic view showing a penetration pattern of a display.

FIG. 3 is a schematic view showing an electronic device according to a preferred embodiment of this disclosure.

FIG. 4 is a schematic top view showing another example of a sensing cell.

FIG. 5 is a schematic block diagram showing a sensing chip and a processor.

FIG. 6 is a schematically partial cross-sectional view showing a fingerprint sensor of FIG. 3.

### SYMBOLS

A: transversal dimension
F: finger
P: transversal pitch
Q1: curve group
Q2: curve group
T1, T2, T3: characteristic curve
10: display
12: display pixel
20: fingerprint sensor
21: sensing chip
22: sensing cell
22A: sub-sensing cell
23: metal wiring layer
24: dielectric layer
25: optical module
27: front processing unit
28: binning unit
30: battery
40: transmission interface
100: electronic device

### DETAILED DESCRIPTION OF THE INVENTION

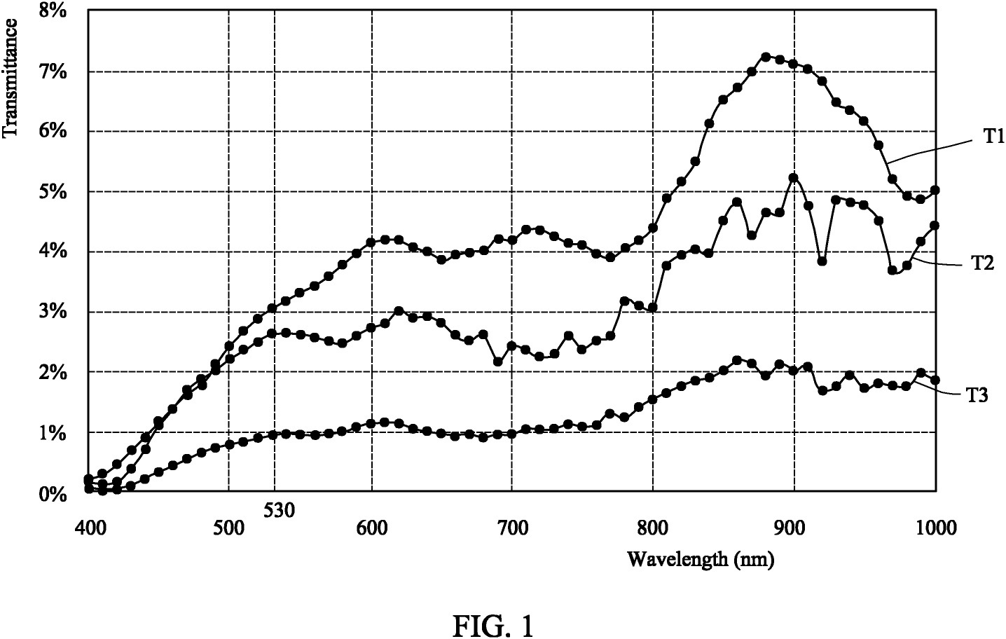

FIG. 1 is a characteristic graph showing examples of displays having different transmission rates. Referring to FIG. 1 showing characteristic curves T1 and T2 of wavelengths of current OLED displays versus transmission rates, the transmission rates for the light having the wavelength of 530 nm range from about 2% to 3%. For example, the transmission rates of the characteristic curves T1 and T2 are 3.1% and 2.5%, respectively. Because the resolution of the OLED display is continuously increased, new materials need to be used, and the density of the display units and the wiring density need to be increased, so that the transmission rate of the future OLED display can be decreased. Regarding a characteristic curve T3 corresponds to the wavelength of the future display versus the transmission rate thereof, the transmission rate for the light having the wavelength of 530 nm is about 1% or even lower. The fingerprint sensor of this disclosure is designed in conjunction with the display having the characteristic curve T3. So, the transmission rate of the display for the light having the wavelength ranging from 500 nm to 850 nm is smaller than 2% (e.g., between 1% and 2%). Alternatively, the transmission rate of the display for the light having the wavelength of 530 nm is smaller than 1%.

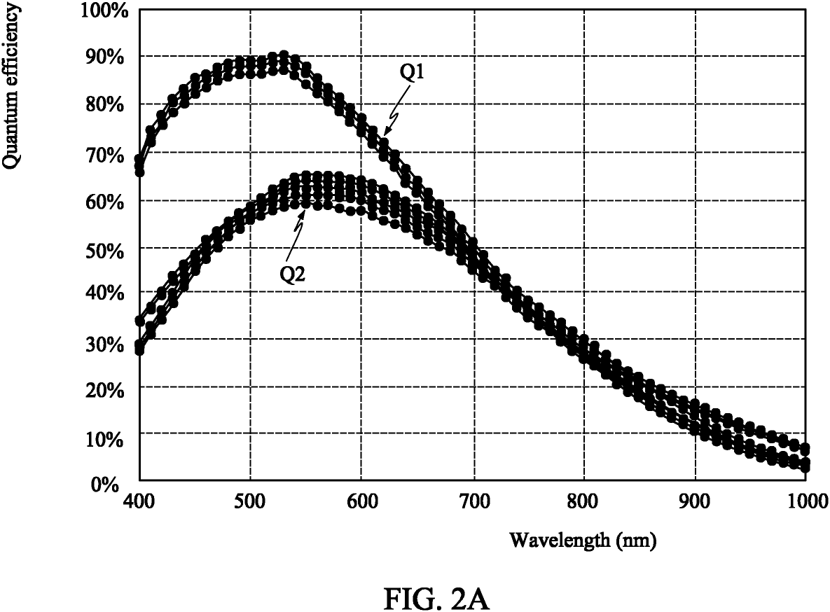

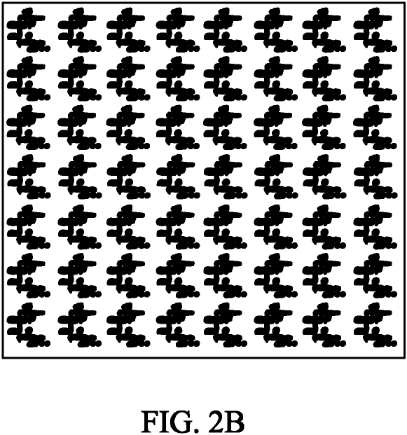

FIG. 2A is a characteristic graph showing two fingerprint sensors. Referring to FIG. 2A, a curve group Q1 represents the relationship between the wavelength and the quantum efficiency of the BSI sensor, while a curve group Q2 represents the relationship between the wavelength and the quantum efficiency of the FSI sensor. For the light having the wavelength of 530 nm, the quantum efficiency of the BSI sensor may reach about 90%, while the quantum efficiency of the FSI sensor is about 60%. Therefore, the BSI sensor is preferred for the future low transmittance display in this disclosure.

Because the fingerprint is applied to, for example, a mobile phone system, the total time required from exposure to the image transmission, recognition and comparison is typically shorter than 200 ms (milliseconds), and the time for the image transmission, recognition and comparison is almost a constant value. The maximum change resides in the exposure time, which typically needs to be shorter than 100 ms.

When the low transmittance display is present, if the dimension and technology (e.g., FSI) of the optical sensor are still kept unchanged, then the exposure time is longer than 150 ms or even 200 ms, and the system specification cannot be satisfied.

Table 1 lists different pixel dimensions versus different exposure times in the BSI sensor. In order to satisfy the specification of 100 ms, it is found that the pixel dimension needs to be greater than 5 µm.

Table 1

| | |
|---|---|
| Pixel dimension of BSI sensor | Exposure time |
| 5 µm | 115 ms |
| 7 µm | 50 ms |
| 10 µm | 23 ms |

Briefly, if the exposure time needs to be satisfied, then the BSI sensor is selected to have the pixel with the larger size (greater than 5 µm). However, the FOD product is disposed under the display (e.g., OLED) having the resolution and penetration pattern (light-permeable or light-transmittive geometric shape). For example, as shown in FIG. 2B, the white parts represent the opaque region, and the black or shadow parts represent the light-permeable region. When the resolution of the display (e.g., the resolution of the display having the transmission rate ranging from 2% to 3% ranges from about 400 dpi to about 500dpi) interacts with the light-permeable geometric shape, the relatively complicated Moire pattern (complicated diffraction pattern) may be produced.

Therefore, the recognition comparison algorithm needs to contain the image processing method to eliminate the Moire pattern and thus to obtain the clearer fingerprint image.

The gap between ridges of the fingerprint ranges from about 200 µm to about 400 µm, and the pixel’s pitch of the display is smaller than 60 µm (400 dpi), for example. So, if distinguishing is made by the spatial frequency, then the fingerprint pertains to the low frequency signal, while the Moire pattern pertains to the high-frequency signal. Therefore, the embodiment of this disclosure needs to be configured such that the imaging resolution is greater than or equal to the display resolution, so that the high-frequency Moire pattern of the display can be filtered out by subsequent image processing. The associated design conditions will be described later.

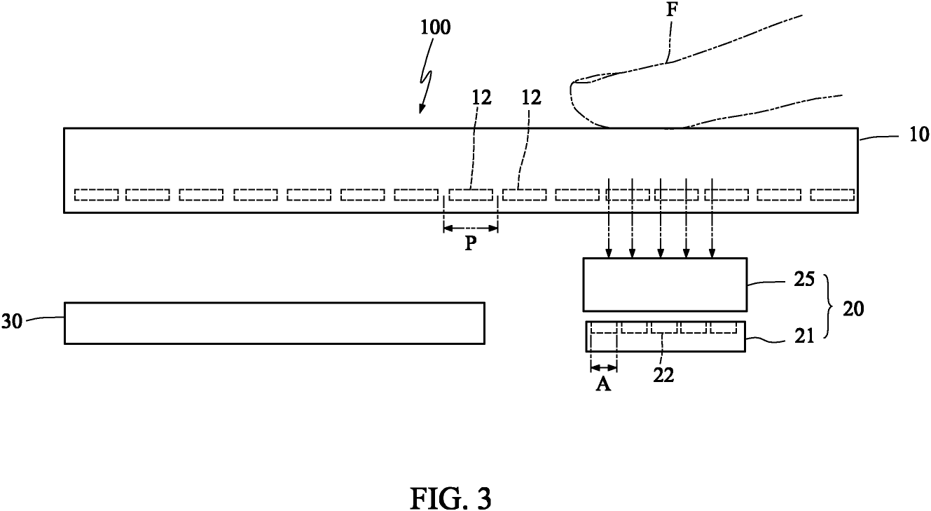

FIG. 3 is a schematic view showing an electronic device according to a preferred embodiment of this disclosure. Referring to FIG. 3, this embodiment provides an electronic device 100, such as a mobile phone, a tablet computer and the like, including a display 10 and a fingerprint sensor 20. Design parameters of the fingerprint sensor 20 and the display 10 need to match with each other.

The display 10 has display pixels 12. A transversal pitch P is formed between adjacent two of the display pixels 12. In FIG. 3, the transversal direction is the horizontal direction. In one example, each display pixel 12 includes three primary color pixels. The display 10 may be an OLED display or any other display with the high resolution.

The fingerprint sensor 20 senses a fingerprint of a finger F disposed on or above the display 10. Because the BSI sensor has the high quantum efficiency, the fingerprint sensor 20 is a BSI fingerprint sensor and includes a sensing chip 21 and an optical module 25.

The sensing chip 21 has sensing cells 22 each having a transversal dimension A, where A > 5 µm. The optical module 25 is disposed between the sensing chip 21 and the display 10, and has a magnification power M. In order to obtain the identifiable fingerprint sensing result under the low transmittance display, this disclosure proposes the following design condition, A × M ≤ P, which is the restriction condition associated with this disclosure and is proved to be implementable after actual tests.

Therefore, a good FOD design includes the four parameters of the exposure time, A, M and P. This disclosure is directed to the next generation of display having the low transmission rate (smaller than 2%, or even smaller than 1%) and the resolution greater than 600 dpi, or even 700 dpi. So, the BSI sensor must have the larger pixel dimension (greater than 5 µm) and the smaller magnification power M to satisfy A × M ≤ P.

The display 10 has the display pixels 12 arranged one by one, and the fingerprint sensor 20 also has the sensing cells 22 arranged one by one. Because the display 10 has many small apertures, multiple periodical light spots and thus the Moire pattern are generated. If the physical cycle of the sensing cells 22 is greater than the cycle of the display pixels 12, the sensing cells 22 cannot sense the periodicity, and the Moire pattern cannot be eliminated by way of image processing. Herein, because the fill factor is designed to be as high as possible, the physical cycle of the sensing cells 22 is equal to about (A × M). That is, the dimension of the display pixel is magnified, by the optical module, into the parameter (A × M), which needs to be smaller than P, so that the sensing cells 22 can sense the changes to facilitate the subsequent image processing.

In one example, the transversal dimension A is greater than 5 µm, or even greater than or equal to 6 µm; and the magnification power M is smaller than or equal to 6, or even smaller than or equal to 5. In another example, the transversal dimension A ranges from 5 µm to 10 µm, and the magnification power M ranges from 6 to 3.

The electronic device 100 may further include a battery 30 for supplying power to the display 10 and the fingerprint sensor 20. The battery 30 is disposed under the display 10 and on one side of the fingerprint sensor 20. It is worth noting that although the fingerprint sensor 20 of FIG. 3 only covers a portion of the display 10, this disclosure is not restricted thereto because the fingerprint sensor 20 may be designed to fully cover the display 10 and implement the full-display fingerprint sensing function.

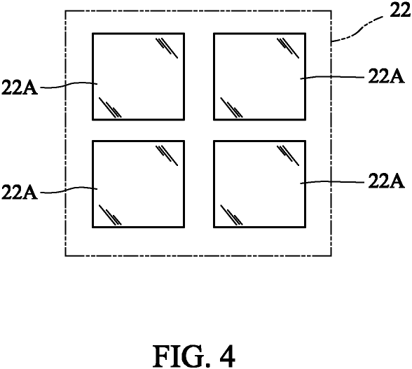

FIG. 4 is a schematic top view showing another example of a sensing cell. Referring to FIG. 4, each sensing cell 22 is constituted by sub-sensing cells 22A arranged in an array, such as a 2 × 2 array, a 3 × 3 array or a larger array without limitation. At this time, the transversal dimension A is equal to a sum of transversal dimensions of two sub-sensing cells 22A. The objective of this configuration is to obtain the image having the higher resolution (e.g., the resolution is quadrupled), so that the Moire pattern problem can be solved more effectively. However, in order to solve the issue of the exposure time, the signals of the sub-sensing cells need to be summated (or binned) by the technology, which is well known in the CIS art and will not be described herein.

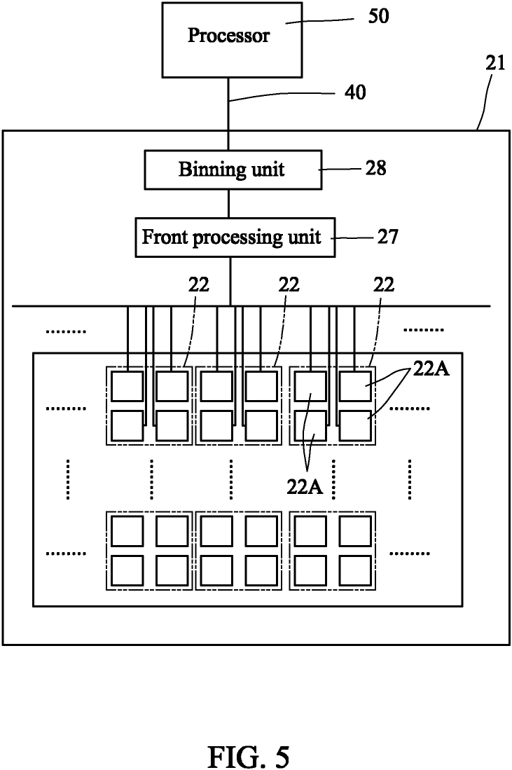

The sensing chip 21 of the fingerprint sensor is connected to a processor 50 of the electronic device 100 through a transmission interface 40, such as a serial peripheral interface (SPI), in the electronic device 100 of the mobile phone system. The SPI transmission speed of the mobile phone system ranges from about 20 MHz to about 30 MHz. If the image data of each sub-sensing cell 22A are firstly transmitted to the mobile phone system and then processed by software, then the SPI transmission time gets too long (sometimes reaches about 50 ms). Therefore, as shown in FIG. 5, the sensing chip 21 of the fingerprint sensor 20 of this disclosure further includes: a front processing unit 27 and a binning unit 28. The front processing unit 27 electrically connected to the sub-sensing cells 22A sequentially captures the image data of the sub-sensing cells 22A (the array image data of the high-resolution sub-sensing cells 22A), and performs front image processing on the image data. That is, the front image processing is performed in the sensing chip 21 by a spatial low-pass filter and the like. The binning unit 28 bins the processed image data into binned image data corresponding to the one of the sensing cells 22. That is, the array image data of the sub-sensing cells 22A are binned into the image data representative of the data obtained by the sensing cell 22 performing image sensing. Then, the image data are outputted, via the SPI transmission interface 40, to the processor 50 of the electronic device 100 performing subsequent image processing, so that the transmission time can be significantly shortened to, for example, one-fourth of the original time. Although the front processing unit and the binning unit are described by functional blocks, they can be merged into one circuit, and may also be implemented by hardware circuits of a front processing circuit and a binning circuit, respectively. In this example, the sensing cells 22 are arranged in a two-dimensional array.

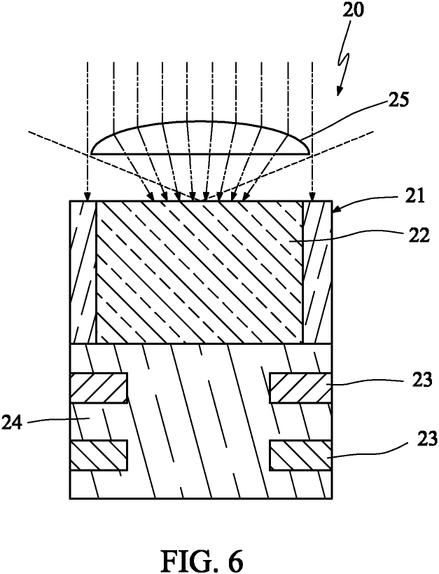

FIG. 6 is a schematically partial cross-sectional view showing the fingerprint sensor 20 of FIG. 3. Referring to FIG. 6, the optical module 25 includes a micro lens for focusing light onto the sensing cell 22, the sensing chip 21 further has one or multiple metal wiring layers 23 (e.g., two metal wiring layers), and the sensing cell 22 is disposed between the optical module 25 and the metal wiring layers 23. A dielectric layer 24 is filled between the metal wiring layers 23. Because the metal wiring layer 23 cannot shield the light from entering the sensing cell 22, the higher quantum efficiency can be obtained, and this is applicable to the above-mentioned embodiment.

With the electronic device having the fingerprint sensor and the high resolution display adapted to each other and configured according to the design condition of A × M ≤ P, the optical fingerprint sensing can be implemented under the high resolution display, and the display and fingerprint sensing requirements of the future and currently developing mobile devices can be satisfied.

The specific embodiments proposed in the detailed description of this disclosure are only used to facilitate the description of the technical contents of this disclosure, and do not narrowly limit this disclosure to the above-mentioned embodiments. Various changes of implementations made without departing from the spirit of this disclosure and the scope of the claims are deemed as falling within the following claims.

1. An electronic device comprising:
a display having display pixels, wherein a transversal pitch P is formed between adjacent two of the display pixels; and
a fingerprint sensor sensing a fingerprint of a finger disposed on or above the display, wherein the fingerprint sensor is a back-side illumination (BSI) fingerprint sensor, and comprises:
a sensing chip having sensing cells each having a transversal dimension A, where A > 5 µm; and
an optical module being disposed between the sensing chip and the display and having a magnification power M, where A × M ≤ P.

2. The electronic device according to claim 1, wherein a transmission rate of the display for light having a wavelength ranging from 500 nm to 850 nm is smaller than 2%.

3. The electronic device according to claim 1, wherein the transversal dimension A ranges from 5 µm to 10 µm.

4. The electronic device according to claim 1, wherein a transmission rate of the display for light having a wavelength of 530 nm is smaller than 1%.

5. The electronic device according to claim 1, wherein a resolution of the display is greater than 600 dpi.

6. The electronic device according to claim 1, wherein the transversal dimension A is greater than or equal to 6 µm.

7. The electronic device according to claim 1, wherein the magnification power M is smaller than or equal to 6.

8. The electronic device according to claim 1, wherein the magnification power M ranges from 6 to 3.

9. The electronic device according to claim 1, wherein the sensing chip further has a metal wiring layer, and the sensing cell is disposed between the optical module and the metal wiring layer.

10. The electronic device according to claim 1, wherein each of the sensing cells is constituted by sub-sensing cells.

11. The electronic device according to claim 10, wherein the sensing chip further has: a front processing unit, which is electrically connected to the sub-sensing cells captures image data of the sub-sensing cells and per-processes the image data into processed image data; and a binning unit binning the processed image data into binned image data, which corresponds to a corresponding one of the sensing cells and is outputted to a processor of the electronic device.
